(19) United States
(12) Patent Application Publication
(10) Pub. No.: US 2007/0005390 A1
(43) Pub. Date: Jan. 4, 2007

(54) BUSINESS CERTIFICATION METHOD

(76) Inventor: Donald Morgan, St. Francisville, LA (US)

Correspondence Address: NEIL J. COIG, 2355 DRUSILLA LANE, BATON ROUGE, LA, 70809, US

(21) Appl. No.: 11/428,404

(22) Filed: Jul. 2, 2006

Related U.S. Application Data
(60) Provisional application No. 60/595,422, filed on Jul. 3, 2005.

(51) Int. Cl. G06Q 99/00

(52) U.S. Cl. 705/1

(57) ABSTRACT

An improved method for certifying service/product providers. This is accomplished by first determining the requirements of operation of such service/product provider, such as insurance coverage, bonding information and the like. These requirements are then verified as being met so that a consumer or business partner need not know or verify the requirements, or verify that the requirements have been sufficiently satisfied. Once all the requirements of the service/product provider are verified by the certifier, the service/product provider's name and other selected information can be published so that potential customers, business partners and/or employers can more easily find the service/product providers which meet not only their needs, but service/product providers which meet all of the legal and regulatory requirements that may be applicable in a given field, geographical area or other subset of the business community.

### BACKGROUND OF THE INVENTION

The present invention relates to a business method for certifying service/product providers to ensure that they meet or exceed all the necessary qualifications to operate in order to protect all potential parties to a transaction or other business relationship.

In the traditional mode of seeking out a service/product provider, that is, a company, individual, partnership or other entity which provides a service or product to the community, an company individual consumer must first seek out a service/product provider by searching typical sources such as a telephone book, internet directory, recommendations of friends or other source in order to find the proper provider. Once a provider is found, the complications and problems inherent in the system become more pronounced. For example, a consumer or other entity seeking this may not even know what qualifications or attributes to look for in a service/product provider, and even if they do, the customer would then have to undertake to verify that all the necessary qualifications are met. Things like insurance, bonding and so forth need all be verified to help ensure that complications are minimized, and the party hiring the service/product provider is protected and shielded against unwanted exposure and potential problems.

Obvious downsides to this current mode of finding a service/product provider exist. Most consumers are not even aware of the requirements that may be legally or administratively binding on a service/product provider, and then, even if they are aware of such requirements, having to research, verify and monitor those qualifications can be a monumental task. Once all those hurdles are met, it may still prove difficult for someone not versed in these requirements to sufficiently understand what is required, to say nothing of if the requirements have been met.

All of these aspects of the current state of the art lead to an increased need for an innovative method for certifying service/product providers on behalf of all parties involved to reduce the complications associated therewith.

The present invention of a business (or service/product provider) certification method is thus a much-improved method of certifying service/product providers to ensure that they meet all applicable qualifications and requirements on behalf of interested parties, such as consumers or other businesses, other service/product providers and any who may seek to hire these service/product providers.

### OBJECTS OF THE INVENTION

One object of the invention is to provide an improved method of certifying service/product providers.

Another object of this invention is to provide a means to publicize verified service/product providers.

Yet another object of this invention is to provide the community access to legitimate and properly credentialed service/product providers.

Still another object of this invention is to provide a less burdensome method for customers, potential business partners and employers to find and verify the information and background of service/product providers.

Other objects and advantages of this invention shall become apparent from the ensuing descriptions of the invention.

### SUMMARY OF THE INVENTION

According to the present invention, an improved method for certifying service/product providers is disclosed. This is accomplished by first determining the requirements of operation and preferred characteristics of such service/product provider, such as insurance coverage, bonding information and the like. These requirements are then verified as being met so that a consumer or business partner need know neither the requirements, nor verify that such requirements have been sufficiently satisfied. Once all the requirements of the service/product provider are verified by the certifier, the service/product provider's name and other selected information can be published so that potential customers, business partners and/or employers can more easily find the service/product providers which meet not only their needs, but service/product providers which meet all of the legal and regulatory requirements that may be applicable in a given field, geographical area or other subset of the community at large.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 is a flow chart illustrating the certification process.

### DETAILED DESCRIPTION OF EXEMPLARY EMBODIMENTS

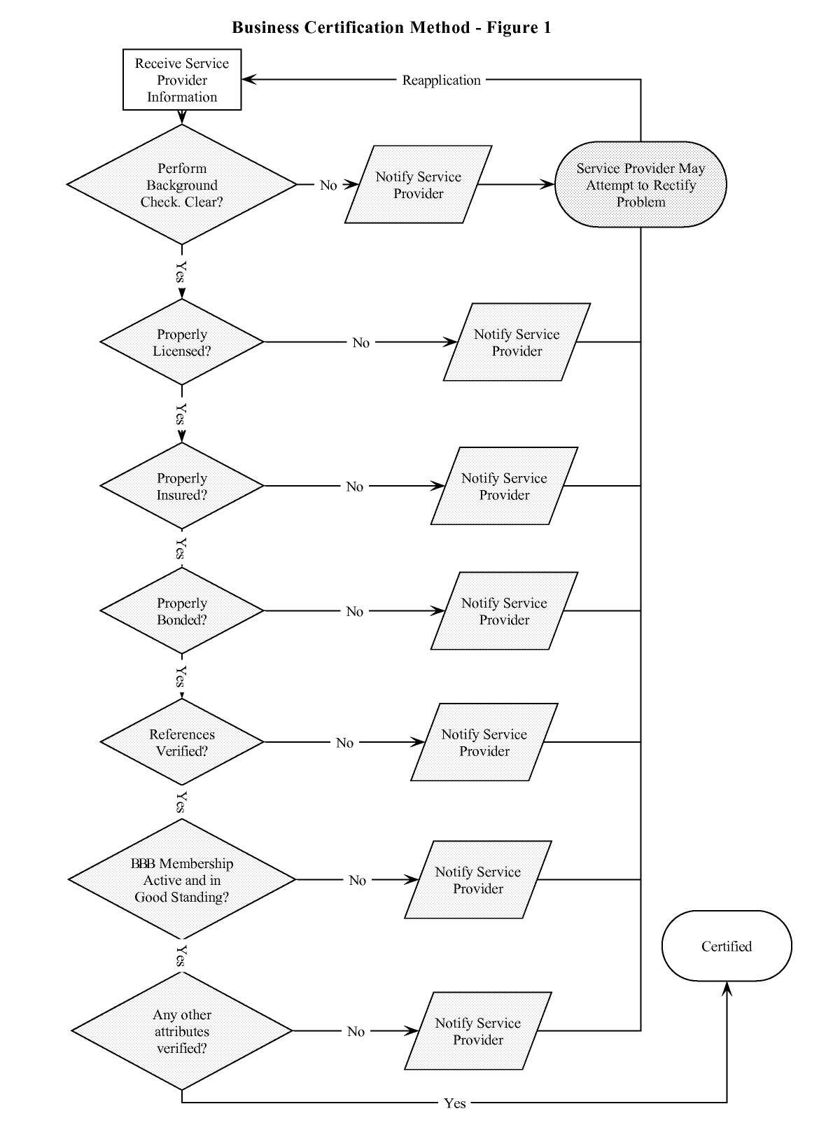

Without any intent to limit the scope of this invention, reference is made to the figures in describing the various embodiments of the invention. FIG. 1 shows various aspects of an exemplary embodiment of the present invention.

The present invention relates to a one-of-a-kind, new concept that has been developed to fill the general populations' need to easily distinguish qualified, insured, and reliable service/product providers from those who may be untrained, uninsured, and/or unethical. This need continually demonstrates itself by the daily news of innocent, elderly and needy victims who suffer damage and emotional pain from unscrupulous impostors or individuals operating businesses without the proper qualifications, liability insurance, or required workers' compensation insurance. Even in cases of legitimate businesses, an oversight can permit an insurance lapse or other failure for renewal of bonding or licensing. Any or all of these problems can lead to more complications, such as lawsuits, unrecoverable claims against dissolved businesses and more.

The proposed invention is much more than just a directory listing of service/product providers which can contain any information or claims that any one service/product provider desires just by purchasing an ad or other placement in a directory. To be published on the list of approved service/product providers as a certified service/product provider, a service/product provider must submit an application for certification, which verifies several key pieces of data on a service/product provider, and ensures legal compliance and further that other key elements of a service/product provider are met.

First, information is collected regarding a service/product provider. A thorough background check is then performed on the service/product provider to ensure there is no negative information regarding the service/product provider and/or it principals or employees, if desired. Any applicable licensing requirement is determined as to its currency to ensure proper licensure. Insurance coverage is then verified, both for liability insurance held by the service/product provider, as well as worker's compensation insurance, when applicable. Service/product providers which are required to have a bond will also have that bond verified. Multiple references will also be required to be disclosed as character references for the service/product provider, and then those same references will be verified by the certifier. Often, if there is a local Better Business Bureau chapter, membership without outstanding complaints will be verified as well. Other, similar legal or administrative aspects may also be verified, depending on the local rules, laws and regulations and/or revisions of the same which may cause a change in what is or is not required or preferred of a service/product provider.

Other information regarding the service/product provider may also be verified, such as new licensure requirements as they emerge, improved insurance aspects or other information that may reasonably be ascertained by the certifier about the service/product provider. Of course, even further criteria can be utilized to determine whether a service/product provider is able to be certified, and the needs may change over time based on new challenges, or consumer demand. For example, customers may begin to demand that all employees be screened for criminal activity. Service/product providers may seek to get additional exposure through other media, such as a printed directory, or special phone book listings. Licensing or certification of service/product providers in different ways may also emerge, however, this method is to be construed as encompassing certification of a service/product provider for due diligence to reduce the risk of problems for consumers, regardless of what criteria are used to make that determination. Specialized demands may also be met by the certifier, such as if a government agency wanted to certify all of their contractors with regard to particular characteristics, the certifier could tailor the list of verified information to meet a particular purpose.

Further, new media channels and regulatory processes may dictate changes in presentation of information and what can, cannot or should be provided. Again, such variations in the type of information to be submitted and/or the method of same should not be considered a departure from the basic tenets of this invention, which are to provide a series of standards for service/product providers in order that only those service/product providers who meet or exceed that standard will be eligible for inclusion in the certifier's published list of those who have been certified, no matter where or how that directory may be kept, in order that consumers may freely access those service/product providers for a marked reduction in disputes, and an increase in the overall quality of business, business relationship and consumer satisfaction, plus myriad other benefits that arise both in the long and short term by the use of this method.

Once all of this information is satisfactorily demonstrated to be met, the service/product provider is certified, and thus able to boast the certification. Further, as part of this promotion, the certifier would keep a published list of service/product providers which have met and continue to meet the requirements (via a recurring certification, such as annually, biannually, biennially, etc.) mentioned above for access by the public and/or other interested parties. This could be any target group, such as the public as a whole, or industry groups, targeted campaigns or the like. Further, the certifier may permit the service/product provider to use a certification mark or other indicia to demonstrate compliance with the certifier's requirements.

This service certifier method will also provide certified service/product providers easy access to consumers through an internet or other web presence and by instant recognition as a trusted and qualified product or service/product provider. This will relieve service/product providers of the expense, hassle, and difficult task of trying to separate themselves from their unqualified and less reputable competitors. At the same time the certifier will provide them access to the ever growing market of savvy consumers who use the internet to research before buying a product or service. Consumers will come to know that working through certifier is a more prudent, efficient, and less risky way to select a product or service/product provider.

In operation, then, the certification process is able to serve many segments of the market in which a service/product provider operates. For example, for going concerns, utilizing this method is able to provider ongoing continuous third-party verification of licensing and insurance status to prevent lapses in coverage and costly litigation or penalties and fines for failure to be properly credentialed. The benefit of reducing the administrative burden of performing the task of verifying this information, as well as reducing the possibility and/or frequency with which a going concern may be involved with parties which do not meet these requirements is another effect.

A user of the certification system is also able to track this information to keep apprised of multiple business partners and or associates which may need to be monitored. Keeping tabs on this information can not only reduce the number and cost of claims against a certified service/product provider (or those who deal with them), but have far-reaching effects, such as reduced insurance premiums due to fewer claims and litigation due to the certifier's diligence in providing only qualified and preferred service/product providers with which to do business.

A party seeking certification maintains the benefit of having increased exposure to other parties from potential employers, partners and/or customers by virtue of the publication of the service/product provider's name and selected information such as address, phone number and service location. The certified service/product provider is also benefited by being listed only with other service/product providers which are licensed and properly insured and so forth, essentially putting competitors on a level playing field, since they are no longer compared to cheaper or less-credentialed service/product providers who are able to provide the reduced cost by reducing expenditures on licensing, insurance and the like.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A method for certifying service/product providers comprising the steps of:
a. collecting information about said service/product providers;
b. performing a background check on said service/product providers;
c. verifying that the proper licenses are held by said service/product providers;
d. verifying proper insurance coverage of said service/product providers;
e. verifying applicable bond coverage of said service/product providers;
f. verifying references of said service/product providers; and
g. verifying better business bureau membership.

2. The method of certifying service/product providers of claim 1 wherein said insurance coverage is liability insurance.

3. The method of certifying service/product providers of claim 1 wherein said insurance coverage is worker's compensation insurance.

4. The method of certifying service/product providers of claim 1 wherein said insurance coverage is worker's compensation and liability insurance.

5. The method of certifying service/product providers of claim 1 further comprising the step of publishing said service/product providers names in a manner permitting public access to said names.

6. The method of certifying service/product providers of claim 5 wherein said publication step is the dissemination of said service/product providers on the internet.

7. The method of certifying service/product providers of claim 1 further comprising the step of authorizing the service/product provider to use a certification mark indicating its certification.

8. The method of certifying service/product providers of claim 1 further comprising the step of a recurring certification to ensure ongoing compliance.

9. A method for certifying service/product providers comprising the steps of:
a. collecting information about said service/product providers;
b. verifying that essential requirements of said service/product providers are met and maintained;
c. publishing selected information about a service/product provider to a selected target group.

10. The method of certifying service/product providers of claim 9 wherein said insurance coverage is liability insurance.

11. The method of certifying service/product providers of claim 9 wherein said insurance coverage is worker's compensation insurance.

12. The method of certifying service/product providers of claim 9 wherein said insurance coverage is worker's compensation and liability insurance.

13. The method of certifying service/product providers of claim 9 further comprising the step of publishing said service/product providers names in a manner permitting public access to said names.

14. The method of certifying service/product providers of claim 13 wherein said publication step is the dissemination of said service/product providers on the internet.

15. The method of certifying service/product providers of claim 9 further comprising the step of authorizing the service/product provider to use a certification mark indicating its certification.

16. The method of certifying service/product providers of claim 9 further comprising the step of a recurring certification to ensure ongoing compliance.
